(19) United States
(12) Patent Application Publication
(10) Pub. No.: US 2025/0226382 A1
(43) Pub. Date: Jul. 10, 2025

(54) LITHIUM METAL INTERCALATION IN A BATTERY CELL

(71) Applicant: Apple Inc., Cupertino, CA (US)

(72) Inventors: Jinjun Shi, San Jose, CA (US); Yanning Song, Cupertino, CA (US); Jian Hong, Cupertino, CA (US)

(21) Appl. No.: 18/968,987

(22) Filed: Dec. 4, 2024

Related U.S. Application Data
(60) Provisional application No. 63/617,590, filed on Jan. 4, 2024.

(51) Int. Cl. H01M 4/04; H01M 10/04; H01M 50/109; H01M 50/559; H01M 50/586

(52) U.S. Cl. CPC H01M 4/0447; H01M 10/0427; H01M 50/559; H01M 50/586; H01M 50/109

(57) ABSTRACT

A small format lithium-ion battery cell pre-lithiation assembly includes an enclosure having a first portion corresponding to a first battery cell terminal and a second portion corresponding to a second battery cell terminal. The assembly also includes an electrical insulator contacting the first portion and the second portion, a first lithium metal foil disposed in the enclosure and abutting the first portion, and a second lithium metal foil disposed in the enclosure and abutting the second portion. The assembly also includes an electrode assembly disposed in the enclosure between the first lithium metal foil and the second lithium metal foil.

### CROSS-REFERENCE TO RELATED APPLICATION

This application claims priority to U.S. Provisional Application No. 63/617,590, entitled “LITHIUM METAL INTERCALATION IN A BATTERY CELL,” filed Jan. 4, 2024, which is incorporated by reference herein in its entirety.

### BACKGROUND

The present disclosure relates generally to batteries, such as secondary or rechargeable batteries (e.g., lithium-ion batteries), and more specifically to lithium metal intercalation (e.g., in-situ intercalation) in said batteries.

Certain batteries, such as those described above, may undergo a pre-lithiation process causing lithium ions (Li+) to react with an anode of the battery cell during formation of the battery cell (e.g., prior to using the battery cell for powering a load). Pre-lithiation processes may employ this oxidation-reduction (redox) reaction to reduce or mitigate initial active lithium loss that occurs during cycling stages (e.g., early cycling stages) of the battery cell, improve local voltage uniformity, and/or maintain cell stability and performance. Unfortunately, traditional pre-lithiation processes may be cumbersome, expensive, inadequate, and/or ineffective. Accordingly, it is now recognized that improved systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a small format lithium-ion battery cell pre-lithiation assembly includes an enclosure having a first portion corresponding to a first battery cell terminal and a second portion corresponding to a second battery cell terminal. The assembly also includes an electrical insulator contacting the first portion and the second portion, a first lithium metal foil disposed in the enclosure and abutting the first portion, and a second lithium metal foil disposed in the enclosure and abutting the second portion. The assembly also includes an electrode assembly disposed in the enclosure between the first lithium metal foil and the second lithium metal foil.

In another embodiment, a small format battery cell pre-lithiation assembly includes an enclosure, a first lithium metal foil disposed in the enclosure and abutting a first portion of the enclosure, and a second lithium metal foil disposed in the enclosure and abutting a second portion of the enclosure. The first portion of the enclosure corresponds to a first battery cell terminal and the second portion of the enclosure corresponds to a second battery cell terminal. The assembly also includes an electrical insulator electrically isolate the first portion from the second portion.

In another embodiment, a method of forming a small format battery cell includes disposing a first lithium metal foil in a battery cell enclosure such that the first lithium metal foil contacts a first portion of the battery cell enclosure, where the first portion corresponds to a first battery cell terminal. The method also includes disposing a second lithium metal foil in the battery cell enclosure such that the second lithium metal foil contacts a second portion of the battery cell enclosure, where the second portion opposes the first portion and corresponds to a second battery cell terminal. The method also includes administering a pre-lithiation process such that active lithium corresponding to the first lithium metal foil and the second lithium metal foil is transferred to a battery cell anode of a battery cell electrode assembly.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is an exploded perspective view of a first type of battery cell (e.g., a first type of small format lithium-ion battery cell) following a pre-lithiation process, according to embodiments of the present disclosure;

FIG. 2 is a cross-sectional view of a first type of battery cell pre-lithiation assembly (e.g., a first type of small format lithium-ion battery cell pre-lithiation assembly) employed to form a first type of battery cell, according to embodiments of the present disclosure;

FIG. 3 is a cross-sectional view of a first type of battery cell (e.g., a first type of small format lithium-ion battery cell) following a pre-lithiation process, according to embodiments of the present disclosure;

FIG. 4 is an exploded perspective view of a second type of battery cell (e.g., a second type of small format lithium-ion battery cell) following a pre-lithiation process, according to embodiments of the present disclosure;

FIG. 5 is a cross-sectional view of a second type of battery cell pre-lithiation assembly (e.g., a second type of small format lithium-ion battery cell pre-lithiation assembly) employed to form a second type of battery cell, according to embodiments of the present disclosure;

FIG. 6 is a cross-sectional view of a second type of battery cell (e.g., a second type of small format lithium-ion battery cell) following a pre-lithiation process, according to embodiments of the present disclosure;

FIG. 7 is an exploded perspective view of a third type of battery cell (e.g., a third type of small format lithium-ion battery cell) following a pre-lithiation process, according to embodiments of the present disclosure;

FIG. 8 is a cross-sectional view of a third type of battery cell pre-lithiation assembly (e.g., a third type of small format lithium-ion battery cell pre-lithiation assembly) employed to form a third type of battery cell, according to embodiments of the present disclosure;

FIG. 9 is a cross-sectional view of a third type of battery cell (e.g., a third type of small format lithium-ion battery cell) following a pre-lithiation process, according to embodiments of the present disclosure; and

FIG. 10 is a process flow diagram illustrating a method of forming a battery cell (e.g., small format lithium-ion battery cell) via a battery cell pre-lithiation assembly (e.g., small format lithium-ion battery cell pre-lithiation assembly), according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on.

The present disclosure relates generally to batteries, such as secondary or rechargeable batteries (e.g., lithium-ion batteries), and more specifically to lithium metal intercalation (e.g., in-situ intercalation) in said batteries.

A secondary or rechargeable battery cell (e.g., lithium-ion battery cell) may include, among other features, electrodes (e.g., at least one anode and at least one cathode), at least one separator, an electrolyte, and an enclosure in which the electrodes, the at least one separator, and the electrolyte are disposed. The electrodes and the separator(s) of the battery cell may be referred to herein as an electrode assembly. In some embodiments, the electrode assembly is wound into a jelly roll, while in other embodiments, the electrode assembly is arranged in a stacked configuration or other type of configuration.

The present disclosure includes, among other types of battery cells, small format battery cells employable in various consumer electronics (e.g., mobile phones, watches, laptops, microphones, remote controllers, etc.). The small format battery cell may include a button cell having a generally cylindrical shape. For example, the enclosure of the button cell may form at least a portion of the generally cylindrical shape. Typical button cells include a height (e.g., maximum height) in a height range of 2 millimeters and 7 millimeters (e.g., approximately 0.08 inches and 0.28 inches) and a diameter (e.g., maximum diameter) in a diameter range of 5 millimeters and 15 millimeters (e.g., approximately 0.2 inches and 0.6 inches). The button cells may include a height to diameter ratio within a range of 2:15 (e.g., approximately 0.133) and 7:5 (e.g., approximately 1.4). In these and/or other types of battery cells according to the present disclosure, the enclosure may include a first portion acting as a first terminal of the battery cell and a second portion acting as a second terminal of the battery cell. An electrical insulator may be disposed between the first portion and the second portion such that the first terminal formed by the first portion is electrically isolated from the second terminal formed by the second portion. In this way, the first portion, the second portion, and the electrical insulator are joined to form an interior of the enclosure. The electrode assembly, such as a jelly roll, and the electrolyte of the battery cell may be disposed within the interior of the enclosure.

A battery cell in accordance with the present disclosure may be cycled through various discharging and charging sequences during a lifetime of the battery cell. In traditional configurations, initial active lithium loss may occur in certain of these cycles (e.g., early cycles), which may affect battery cell stability, performance, longevity, and/or energy density. In accordance with the present disclosure, a pre-lithiation process may be administered that introduces a lithium source in a battery cell pre-lithiation assembly acting as a precursor to the battery cell, where the lithium source mitigates initial active lithium loss and improves local voltage uniformity, battery performance, and battery stability, among other technical benefits.

For example, prior to complete formation of the battery cell, a first lithium metal source (e.g., first lithium metal foil) may be disposed within the interior of the enclosure and in contact with the first portion, or first battery cell terminal, of the enclosure. Further, a second lithium metal source (e.g., second lithium metal foil) may be disposed within the interior of the enclosure and in contact with the second portion, or second battery cell terminal, of the enclosure. Disposal of the first and second lithium metal sources in the interior of the enclosure of the battery cell may be referred to herein as intercalation (e.g., in-situ intercalation). The first lithium metal source, the second lithium metal source, and other features (e.g., the enclosure, the electrode assembly, electrolyte, other componentry, or a combination thereof) may be referred to as a battery cell pre-lithiation assembly.

As described above, the battery cell pre-lithiation assembly is a precursor to the battery cell. Indeed, a pre-lithiation process may be administered to the battery cell pre-lithiation assembly during formation of the battery cell, which may deplete the lithium metal source(s). For example, in some embodiments, a voltage applicator is employed to apply a voltage to the battery cell pre-lithiation assembly (e.g., to at least one of the lithium metal sources, or foils) during the pre-lithiation process, which may cause a redox reaction between Li+ ions and the anode(s), such that active lithium is transferred from the lithium metal source(s) to the anode(s), thereby reducing, negating, or otherwise preventing initial active lithium loss and/or local voltage non-uniformity.

As described above and in more detail below, presently disclosed systems and techniques enable improved local voltage uniformity, compensated initial active lithium loss, and improved battery cell performance, stability, longevity, and energy density over traditional systems and techniques. Further, presently disclosed systems and techniques may be less expensive and cumbersome than traditional systems and techniques. It should be noted that, while certain embodiments of the present disclosure are discussed in the context of small format lithium-ion battery cells (e.g., lithium-ion button cells), similar systems and techniques may be employed in other batteries with other sizes and/or material compositions. These and other aspects of the present disclosure are described in detail below with reference to the drawings.

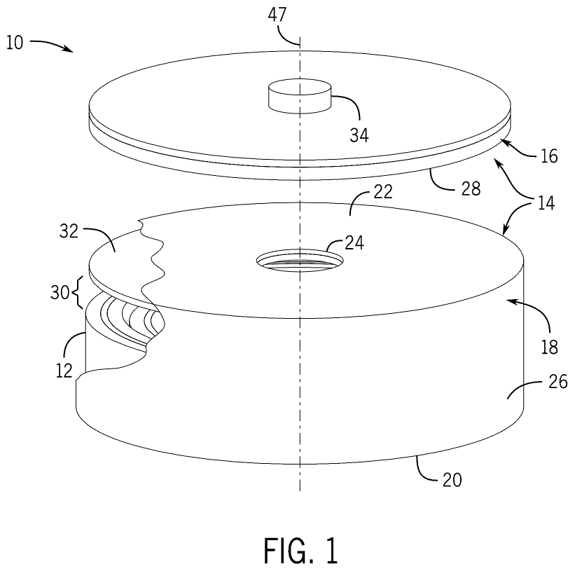

FIG. 1 is an exploded perspective view of an embodiment of a battery cell 10 (e.g., small format lithium-ion battery cell) including an electrode assembly 12 (e.g., jelly roll) having at least one anode, at least one cathode, and at least one separator (e.g., porous separator) disposed between the anode and the cathode. The electrode assembly 12 and an electrolyte of the battery cell 10 are disposed in an enclosure 14. The enclosure 14 includes a first portion 16, which acts as a first terminal of the battery cell 10, and a second portion 18, which acts as a second terminal of the battery cell 10.

While the first portion 16 of the enclosure 14 is shown above the second portion 18 of the enclosure 14 in the exploded perspective view of FIG. 1, it should be understood that the first portion 16 is generally disposed at least partially inside of the second portion 18. For example, the second portion 18 of the enclosure 14 includes a first wall 20 (e.g., circular or disk-shaped wall), a second wall 22 (e.g., annulus wall) opposing the first wall 20 and having an opening 24 therein, and a third wall 26 (e.g., cylindrical wall or body) extending from the first wall 20 to the second wall 22. A body 28 of the first portion 16 of the enclosure 14 may be disposed in a gap 30 formed between the electrode assembly 12 and an electrical insulator 32 and residing within the second portion 18 of the enclosure 14. The electrical insulator 32 operates to electrically isolate the first battery cell terminal corresponding to (e.g., formed by) the first portion 16 of the enclosure 14 from the second battery cell terminal corresponding to (e.g., formed by) the second portion 18 of the enclosure 14. Further, the first portion 16 includes a terminal contact 34 extending from the body 28 of the first portion 16 and configured to extend through the opening 24 in the second wall 22 of the second portion 18 of the enclosure 14. In this way, an electrical distribution system configured to interface the battery cell 10 with a load may access both the first portion 16 (e.g., first battery cell terminal) and the second portion 18 (e.g., second battery cell terminal) of the enclosure 14.

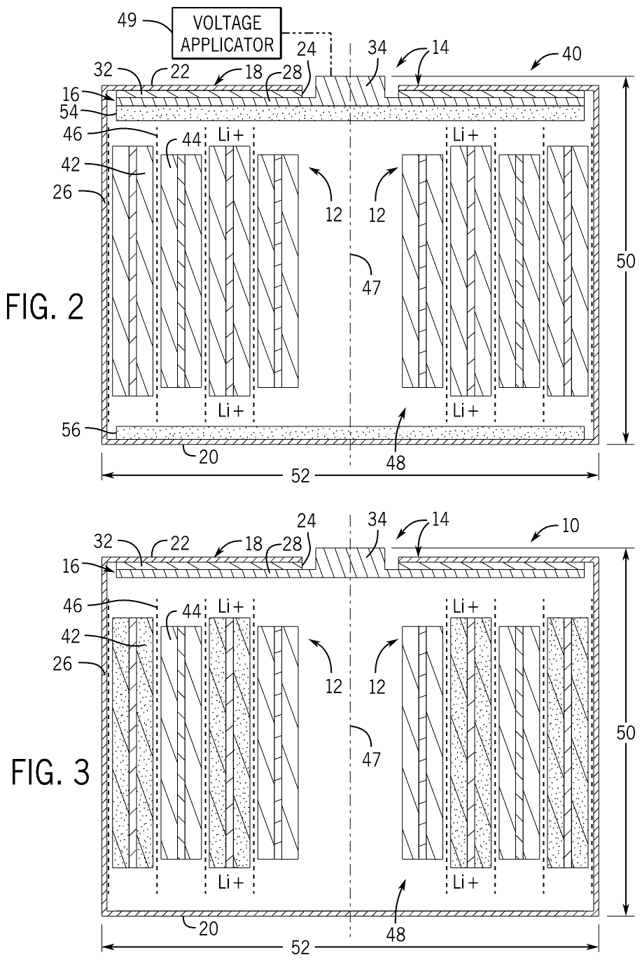

FIG. 1 is representative of an embodiment of the battery cell 10 formed via a battery cell pre-lithiation assembly in accordance with the present disclosure. That is, the battery cell pre-lithiation assembly may be a precursor to the battery cell 10 prior to complete formation of the battery cell 10. FIG. 2 is a cross-sectional view of an embodiment of a battery cell pre-lithiation assembly 40 employed to form the battery cell 10, and FIG. 3 is a cross-sectional view of an embodiment of the battery cell 10 following administration of a pre-lithiation process (e.g., to the battery cell pre-lithiation assembly 40 in FIG. 2). Focusing first on FIG. 2, the battery cell pre-lithiation assembly 40 includes a number of the same or similar components included in the battery cell 10. For example, the battery cell pre-lithiation assembly 40 includes the first and second portions 16, 18 of the enclosure 14, the electrical insulator 32 between the first portion 16 and the second portion 18, and the electrode assembly 12 (e.g., jelly roll). As shown in FIG. 2, the electrode assembly 12 includes at least one anode 42, at least one cathode 44, and at least one separator 46 (e.g., porous separator). For example, the separator 46 may be disposed between the anode 42 and the cathode 44, and the electrode assembly 12 including the anode 42, the cathode 44, and the separator 46 may be wound into a jelly roll configuration (e.g., centered on a central axis 47 of the battery cell pre-lithiation assembly 40 of FIG. 2 and/or the battery cell 10 of FIG. 1). As shown in FIG. 2, the electrode assembly 12 is disposed within an interior 48 of the enclosure 14. In some embodiments, electrolyte may also be disposed within the interior 48 of the enclosure 14 of the battery cell pre-lithiation assembly 40, such that the electrode assembly 12 is wetted (e.g., soaked) by the electrolyte.

As previously described, the battery cell 10 in FIG. 1 may be a small format lithium-ion battery cell (e.g., button cell). Likewise, the battery cell pre-lithiation assembly 40 of FIG. 2 may be a small format battery cell pre-lithiation assembly. For example, a small format embodiment of the battery cell pre-lithiation assembly 40 of FIG. 2 may include a height 50 (e.g., maximum height) within a height range of 2 millimeters and 7 millimeters (e.g., approximately 0.08 inches and 0.28 inches) or 3 millimeters and 5 millimeters (e.g., approximately 0.12 inches and 0.2 inches), a diameter 52 (e.g., maximum diameter) or width (e.g., maximum width) within a diameter or width range of 5 millimeters and 15 millimeters (e.g., approximately 0.2 inches and 0.6 inches) or 7 millimeters and 12 millimeters (e.g., approximately 0.28 inches and 0.47 inches), and a height 50 to diameter 52 ratio within a range of 2:15 (e.g., approximately 0.133) and 7:5 (e.g., approximately 1.4).

As shown in FIG. 2, the battery cell pre-lithiation assembly 40 also includes a first lithium metal source, referred to herein as a first lithium metal foil 54, and a second lithium metal source, referred to herein as a second lithium metal foil 56. The first lithium metal foil 54 is disposed in the interior 48 of the enclosure 14 and in contact with (e.g., abutting) the first portion 16 of the enclosure 14, and the second lithium metal foil 56 is disposed in the interior 48 of the enclosure 14 and in contact with (e.g., abutting) the second portion 18 of the enclosure 14. Disposal of the first and second lithium metal foils 54, 56 in the interior 48 of the enclosure 14 of may be referred to herein as intercalation (e.g., in-situ intercalation). In some embodiments, the first lithium metal foil 54 includes a circular or disk shape, and the second lithium metal foil 56 also includes a circular or disk shape. In other embodiments, the first lithium metal foil 54 includes an annulus, and the second lithium metal foil 56 also includes an annulus. Other shapes of the first and second lithium metal foils 54, 56 are also possible. In general, the first and second lithium metal foils 54, 56 may be oriented transverse to (e.g., substantially perpendicular to) the axis 47. Additionally or alternatively, the first lithium metal foil 54 and the second lithium metal foil 56 may face each other.

After intercalation of the first and second lithium metal foils 54, 56 within the interior 48 of the enclosure 14, a pre-lithiation process may be administered to the battery cell pre-lithiation assembly 40 to cause a redox reaction between the anode 42 and Li+ ions corresponding to the lithium metal foils 54, 56, such that active lithium is transferred from the lithium metal foils 54, 56 to the anode 42), thereby reducing, negating, or otherwise preventing initial active lithium loss and/or local voltage non-uniformity. The pre-lithiation process may be initiated by applying a voltage (e.g., via a voltage applicator 49) to the first lithium metal foil 54 (e.g., by way of the first portion 16 of the enclosure 14) and/or to the second lithium metal foil 56 (e.g., by way of the second portion 18 of the enclosure 14). In other embodiments, the pre-lithiation process may be administered via electrolyte aging and without voltage application, whereby electrolyte disposed in the interior 48 of the enclosure 14 causes the pre-lithiation process to occur over a longer period of time (e.g., days). As the pre-lithiation process is administered, the first and second lithium metal foils 54, 56 may be depleted as the active lithium is transferred therefrom to the anode 42. Accordingly, formation of the battery cell 10 may be completed after the pre-lithiation process is completed with the battery cell pre-lithiation assembly 40. An example cross-sectional view of the battery cell 10 formed from the battery cell pre-lithiation assembly 40 of FIG. 2 is illustrated in FIG. 3, which demonstrates how the first and second lithium metals 54, 56 in FIG. 3 are depleted during the pre-lithiation process.

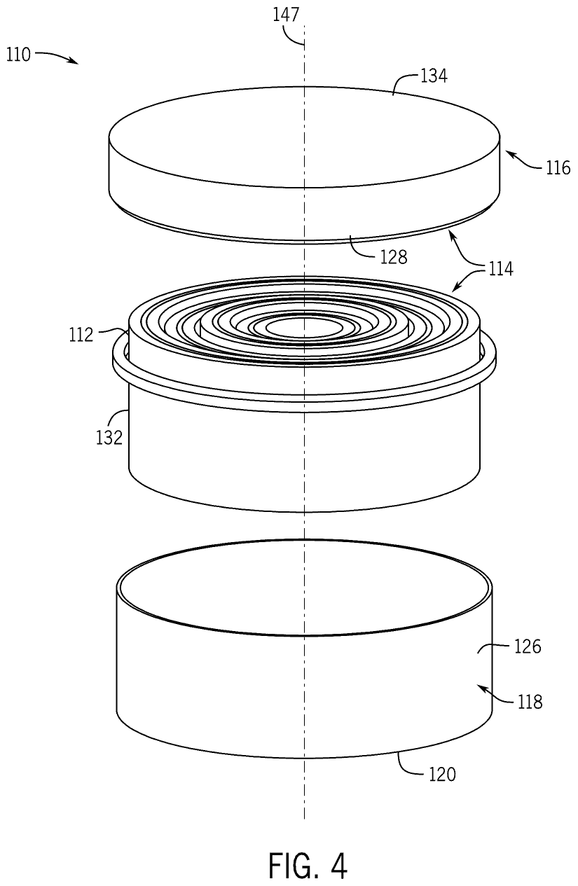

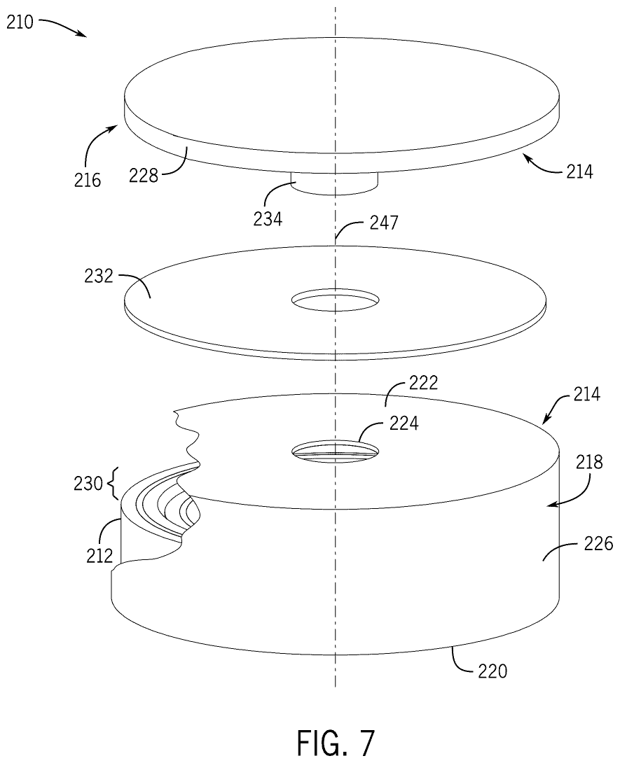

FIGS. 1-3 correspond to a first type of battery cells and pre-lithiation assemblies (e.g., a first type of small format, or button, lithium-ion battery cells and pre-lithiation assemblies), FIGS. 4-6 correspond to a second type of battery cells and pre-lithiation assemblies (e.g., a second type of small format, or button, lithium-ion battery cells and pre-lithiation assemblies), and FIGS. 7-9 correspond a third type of battery cells and pre-lithiation assemblies (e.g., a third type of small format, or button, lithium-ion battery cells and pre-lithiation assemblies). For example, FIG. 4 is an exploded perspective view of an embodiment of a battery cell 110 (e.g., small format lithium-ion battery cell) including an electrode assembly 112 (e.g., jelly roll) having at least one anode, at least one cathode, and at least one separator (e.g., porous separator) disposed between the anode and the cathode. The electrode assembly 112 and an electrolyte of the battery cell 110 are disposed in an enclosure 114. The enclosure 114 includes a first portion 116, which acts as a first terminal of the battery cell 110, and a second portion 118, which acts as a second terminal of the battery cell 110.

The second portion 118 of the enclosure 114 includes a wall 120 (e.g., circular or disk-shaped wall) and an additional wall 126 (e.g., cylindrical wall or body) extending from the wall 120. The first portion 116 of the enclosure 114 also includes a wall 134 (e.g., circular or disk-shaped wall) and an additional wall 128 (e.g., cylindrical wall or body) extending from the wall 134. An electrical insulator 132 operates to electrically isolate the first battery cell terminal corresponding to (e.g., formed by) the first portion 116 of the enclosure 114 from the second battery cell terminal corresponding to (e.g., formed by) the second portion 118 of the enclosure 114. In this way, an electrical distribution system configured to interface the battery cell 110 with a load may access both the first portion 116 (e.g., first battery cell terminal) and the second portion 118 (e.g., second battery cell terminal) of the enclosure 114.

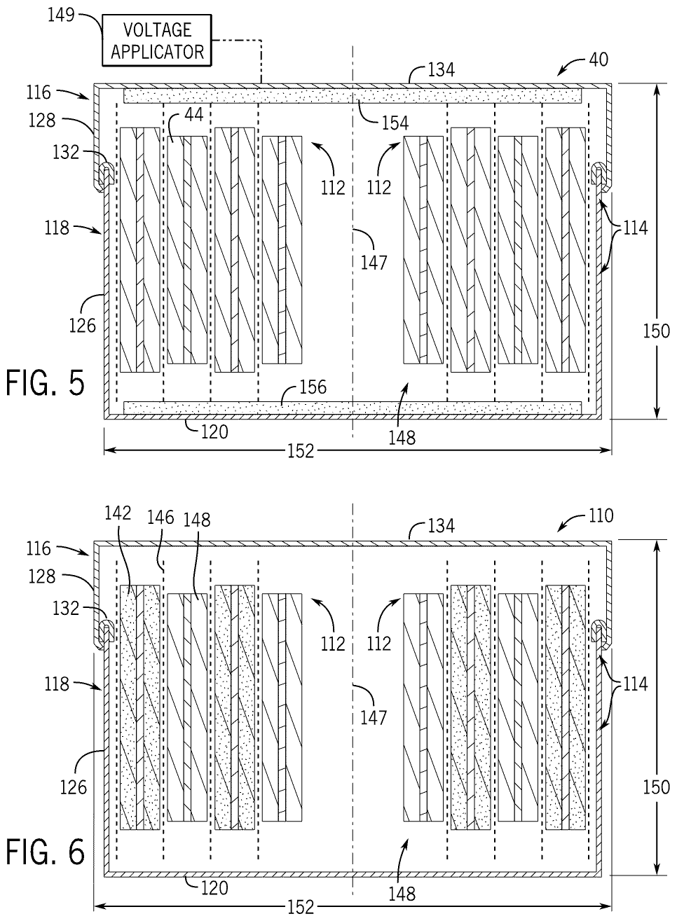

FIG. 4 is representative of an embodiment of the battery cell 110 formed via a battery cell pre-lithiation assembly in accordance with the present disclosure. That is, the battery cell pre-lithiation assembly may be a precursor to the battery cell 110 prior to complete formation of the battery cell 110. FIG. 5 is a cross-sectional view of an embodiment of a battery cell pre-lithiation assembly 140 employed to form the battery cell 110, and FIG. 6 is a cross-sectional view of an embodiment of the battery cell 110 following administration of a pre-lithiation process (e.g., to the battery cell pre-lithiation assembly 140 in FIG. 5). Focusing first on FIG. 5, the battery cell pre-lithiation assembly 140 includes a number of the same or similar components included in the battery cell 110. For example, the battery cell pre-lithiation assembly 140 includes the first and second portions 116, 118 of the enclosure 114, the electrical insulator 132 between the first portion 116 and the second portion 118, and the electrode assembly 112 (e.g., jelly roll). As shown in FIG. 5, the electrode assembly 112 includes at least one anode 142, at least one cathode 144, and at least one separator 146 (e.g., porous separator). For example, the separator 146 may be disposed between the anode 142 and the cathode 144, and the electrode assembly 112 including the anode 142, the cathode 144, and the separator 146 may be wound into a jelly roll configuration (e.g., centered on a central axis 147 of the battery cell pre-lithiation assembly 140 of FIG. 5 and/or the battery cell 110 of FIG. 4). As shown in FIG. 5, the electrode assembly 112 is disposed within an interior 148 of the enclosure 114. In some embodiments, electrolyte may also be disposed within the interior 148 of the enclosure 114 of the battery cell pre-lithiation assembly 140, such that the electrode assembly 112 is wetted (e.g., soaked) by the electrolyte.

As previously described, the battery cell 110 in FIG. 4 may be a small format lithium-ion battery cell (e.g., button cell). Likewise, the battery cell pre-lithiation assembly 140 of FIG. 5 may be a small format battery cell pre-lithiation assembly. For example, a small format embodiment of the battery cell pre-lithiation assembly 140 of FIG. 5 may include a height 150 (e.g., maximum height) within a height range of 2 millimeters and 7 millimeters (e.g., approximately 0.08 inches and 0.28 inches) or 3 millimeters and 5 millimeters (e.g., approximately 0.12 inches and 0.2 inches), a diameter 152 (e.g., maximum diameter) or width (e.g., maximum width) within a diameter or width range of 5 millimeters and 15 millimeters (e.g., approximately 0.2 inches and 0.6 inches) or 7 millimeters and 12 millimeters (e.g., approximately 0.28 inches and 0.47 inches), and a height 150 to diameter 152 ratio between 2:5 (e.g., approximately 0.133) and 7:5 (e.g., approximately 1.4).

As shown in FIG. 5, the cylindrical wall 128 (or body) of the first portion 116 of the enclosure 114 overlaps with the cylindrical wall 128 (or body) of the second portion 118 of the enclosure 114 along an axial direction defined by the axis 147. The electrical insulator 132 operates to electrically isolate the first portion 116 from the second portion 118. In some embodiments, these components are crimped together to form the enclosure 114 defining the interior 148 in which the electrode assembly 112, among other features described in greater detail below, are disposed.

As shown, the battery cell pre-lithiation assembly 140 also includes a first lithium metal source, referred to herein as a first lithium metal foil 154, and a second lithium metal source, referred to herein as a second lithium metal foil 156. The first lithium metal foil 154 is disposed in the interior 148 of the enclosure 114 and in contact with (e.g., abutting) the first portion 116 of the enclosure 114, and the second lithium metal foil 156 is disposed in the interior 148 of the enclosure 114 and in contact with (e.g., abutting) the second portion 118 of the enclosure 114. Disposal of the first and second lithium metal foils 154, 156 in the interior 148 of the enclosure 114 of may be referred to herein as intercalation (e.g., in-situ intercalation). In some embodiments, the first lithium metal foil 154 includes a circular or disk shape, and the second lithium metal foil 156 also includes a circular or disk shape. In other embodiments, the first lithium metal foil 154 includes an annulus, and the second lithium metal foil 156 also includes an annulus. Other shapes of the first and second lithium metal foils 154, 156 are also possible. In general, the first and second lithium metal foils 154, 156 may be oriented transverse to (e.g., substantially perpendicular to) the axis 147. Additionally or alternatively, the first lithium metal foil 154 and the second lithium metal foil 156 may face each other.

After intercalation of the first and second lithium metal foils 154, 156 within the interior 148 of the enclosure 114, a pre-lithiation process may be administered to the battery cell pre-lithiation assembly 140 to cause a redox reaction between the anode 142 and Li+ ions corresponding to the lithium metal foils 154, 156, such that active lithium is transferred from the lithium metal foils 154, 156 to the anode 142), thereby reducing, negating, or otherwise preventing initial active lithium loss and/or local voltage non-uniformity. The pre-lithiation process may be initiated by applying a voltage (e.g., via a voltage applicator 149) to the first lithium metal foil 154 (e.g., by way of the first portion 116 of the enclosure 114) and/or to the second lithium metal foil 156 (e.g., by way of the second portion 118 of the enclosure 114). In other embodiments, the pre-lithiation process may be administered via electrolyte aging and without voltage application, whereby electrolyte disposed in the interior 148 of the enclosure 114 causes the pre-lithiation process to occur over a longer period of time (e.g., days). As the pre-lithiation process is administered, the first and second lithium metal foils 154, 156 may be depleted as the active lithium is transferred therefrom to the anode 142. Accordingly, formation of the battery cell 110 may be completed after the pre-lithiation process is completed with the battery cell pre-lithiation assembly 140. An example cross-sectional view of the battery cell 110 formed from the battery cell pre-lithiation assembly 140 of FIG. 4 is illustrated in FIG. 5, which demonstrates how the first and second lithium metals 154, 156 in FIG. 5 are depleted during the pre-lithiation process.

FIG. 7 is an exploded perspective view of an embodiment of a battery cell 210 (e.g., small format lithium-ion battery cell) including an electrode assembly 212 (e.g., jelly roll) having at least one anode, at least one cathode, and at least one separator (e.g., porous separator) disposed between the anode and the cathode. The electrode assembly 212 and an electrolyte of the battery cell 210 are disposed in an enclosure 214. The enclosure 214 includes a first portion 216, which acts as a first terminal of the battery cell 210, and a second portion 218, which acts as a second terminal of the battery cell 210.

While the first portion 216 of the enclosure 214 is shown above the second portion 218 of the enclosure 214 in the exploded perspective view of FIG. 7, it should be understood that the first portion 216 is generally coupled to (and electrically insulated from) the second portion 218. For example, the second portion 218 of the enclosure 214 includes a first wall 220 (e.g., circular or disk-shaped wall), a second wall 222 (e.g., annulus wall) opposing the first wall 220 and having an opening 224 therein, and a third wall 226 (e.g., cylindrical wall or body) extending from the first wall 220 to the second wall 222. The second portion 218 of the enclosure 214 may also include a gap 230 formed between the electrode assembly 212 and the second wall 222 of the second portion 218 of the enclosure 214. A terminal contact 234 extending from the first portion 216 may extend into the gap 230 via the opening 224 in the second wall 222 of the second portion 218 of the enclosure 214.

A body 228 of the first portion 216 of the enclosure 214 may be electrically separated from the second wall 222 of the second portion 222 of the enclosure 214 via an electrical insulator 232. The electrical insulator 232 operates to electrically isolate the first battery cell terminal corresponding to (e.g., formed by) the first portion 216 of the enclosure 214 from the second battery cell terminal corresponding to (e.g., formed by) the second portion 218 of the enclosure 214. As such, an electrical distribution system configured to interface the battery cell 210 with a load may access both the first portion 216 (e.g., first battery cell terminal) and the second portion 218 (e.g., second battery cell terminal) of the enclosure 214.

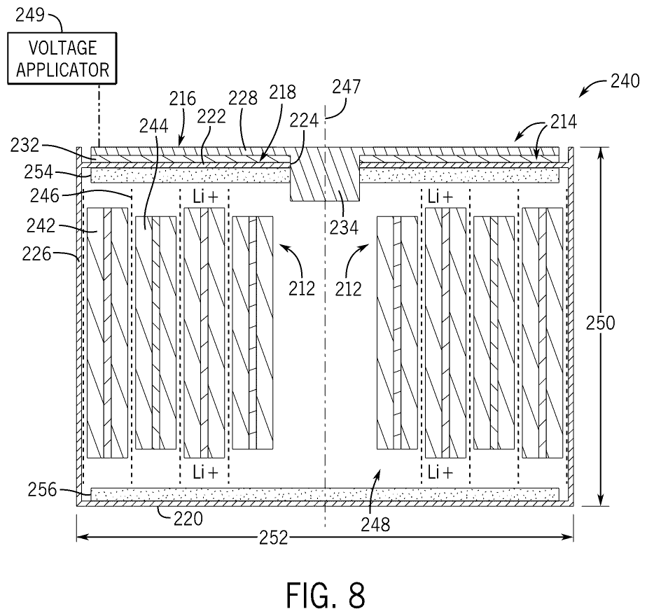

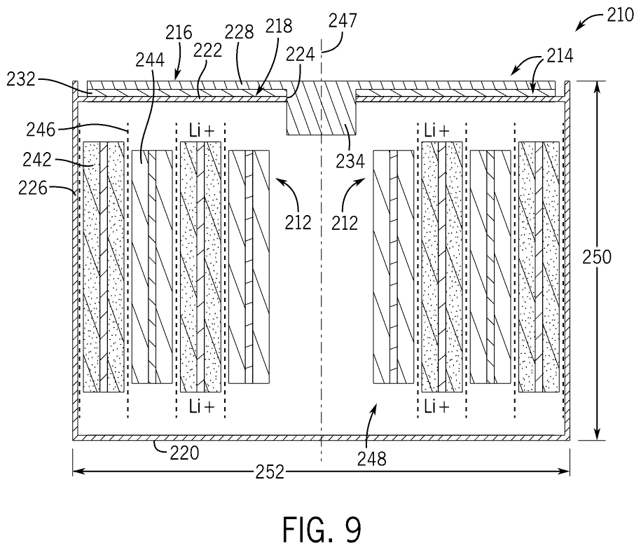

FIG. 7 is representative of an embodiment of the battery cell 210 formed via a battery cell pre-lithiation assembly in accordance with the present disclosure. That is, the battery cell pre-lithiation assembly may be a precursor to the battery cell 210 prior to complete formation of the battery cell 210. FIG. 8 is a cross-sectional view of an embodiment of a battery cell pre-lithiation assembly 240 employed to form the battery cell 210, and FIG. 9 is a cross-sectional view of an embodiment of the battery cell 210 following administration of a pre-lithiation process (e.g., to the battery cell pre-lithiation assembly 240 in FIG. 8).

Focusing first on FIG. 8, the battery cell pre-lithiation assembly 240 includes a number of the same or similar components included in the battery cell 210. For example, the battery cell pre-lithiation assembly 240 includes the first and second portions 216, 218 of the enclosure 214, the electrical insulator 232 between the first portion 216 and the second portion 218, and the electrode assembly 212 (e.g., jelly roll). As shown in FIG. 8, the electrode assembly 212 includes at least one anode 242, at least one cathode 244, and at least one separate cathode 246 (e.g., porous separator). For example, the separator 246 may be disposed between the anode 242 and the cathode 244, and the electrode assembly 212 including the anode 242, cathode 244, and the separator 246 may be wound into a jelly roll configuration (e.g., centered on a central axis 247 of the battery cell pre-lithiation assembly 240 of FIG. 8 and/or the battery cell 210 of FIG. 7). As shown in FIG. 8, the electrode assembly 212 is disposed within an interior 248 of the enclosure 214. In some embodiments, electrolyte may also be disposed within the interior 248 of the enclosure 214 of the battery cell pre-lithiation assembly 240, such that the electrode assembly 212 is wetted (e.g., soaked) by the electrolyte.

As previously described, the battery cell 210 in FIG. 7 may be a small format lithium-ion battery cell (e.g., button cell). Likewise, the battery cell pre-lithiation assembly 240 of FIG. 8 may be a small format battery cell pre-lithiation assembly. For example, a small format embodiment of the battery cell pre-lithiation assembly 240 of FIG. 8 may include a height 250 (e.g., maximum height) within a height range of 2 millimeters and 7 millimeters (e.g., approximately 0.08 inches and 0.28 inches) or 3 millimeters and 5 millimeters (e.g., approximately 0.12 inches and 0.2 inches), a diameter 252 (e.g., maximum diameter) or width (e.g., maximum width) within a diameter or width range of 5 millimeters and 15 millimeters (e.g., approximately 0.2 inches and 0.6 inches) or 7 millimeters and 12 millimeters (e.g., approximately 0.28 inches and 0.47 inches), and a height 250 to diameter 252 ratio between 2:5 (e.g., approximately 0.133) and 7:5 (e.g., approximately 1.4).

As shown in FIG. 8, the battery cell pre-lithiation assembly 240 also includes a first lithium metal source, referred to herein as a first lithium metal foil 254, and a second lithium metal source, referred to herein as a second lithium metal foil 256. The first lithium metal foil 254 is disposed in the interior 248 of the enclosure 214 and in contact with (e.g., abutting) the second wall 222 of the second portion 218 of the enclosure 214, and the second lithium metal foil 256 is disposed in the interior 248 of the enclosure 214 and in contact with (e.g., abutting) the first wall 220 of the second portion 218 of the enclosure 214. Disposal of the first and second lithium metal foils 254, 256 in the interior 248 of the enclosure 214 of may be referred to herein as intercalation (e.g., in-situ intercalation). In some embodiments, the first lithium metal foil 254 includes a circular or disk shape, and the second lithium metal foil 256 also includes a circular or disk shape. In other embodiments, the first lithium metal foil 254 includes an annulus, and the second lithium metal foil 256 also includes an annulus. Other shapes of the first and second lithium metal foils 254, 256 are also possible. In general, the first and second lithium metal foils 254, 256 may be oriented transverse to (e.g., substantially perpendicular to) the axis 247. Additionally or alternatively, the first lithium metal foil 254 and the second lithium metal foil 256 may face each other.

After intercalation of the first and second lithium metal foils 254, 256 within the interior 248 of the enclosure 214, a pre-lithiation process may be administered to the battery cell pre-lithiation assembly 240 to cause a redox reaction between the anode 242 and Li+ ions corresponding to the lithium metal foils 254, 256, such that active lithium is transferred from the lithium metal foils 254, 256 to the anode 242), thereby reducing, negating, or otherwise preventing initial active lithium loss and/or local voltage non-uniformity. The pre-lithiation process may be initiated by applying a voltage (e.g., via a voltage applicator 249) to the first lithium metal foil 254 (e.g., by way the first portion 216 of the enclosure 214) and/or to the second lithium metal foil 256 (e.g., by way of the second portion 218 of the enclosure 214). In other embodiments, the pre-lithiation process may be administered via electrolyte aging and without voltage application, whereby electrolyte disposed in the interior 248 of the enclosure 214 causes the pre-lithiation process to occur over a longer period of time (e.g., days). As the pre-lithiation process is administered, the first and second lithium metal foils 254, 256 may be depleted as the active lithium is transferred therefrom to the anode 242. Accordingly, formation of the battery cell 210 may be completed after the pre-lithiation process is completed with the battery cell pre-lithiation assembly 240. An example cross-sectional view of the battery cell 210 formed from the battery cell pre-lithiation assembly 240 of FIG. 8 is illustrated in FIG. 9, which demonstrates how the first and second lithium metals 254, 256 in FIG. 9 are depleted during the pre-lithiation process.

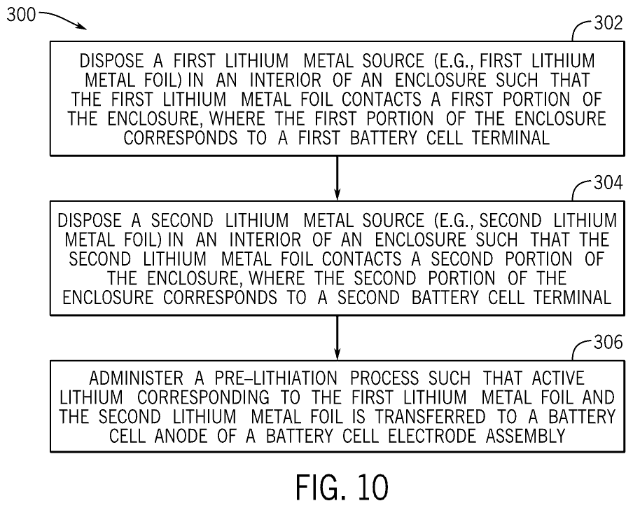

FIG. 10 is a process flow diagram illustrating an embodiment of a method 300 of forming a battery cell (e.g., small format lithium-ion battery cell) via a battery cell pre-lithiation assembly (e.g., small format lithium-ion battery cell pre-lithiation assembly). In the illustrated embodiment, the method 300 includes disposing (block 302) a first lithium metal source (e.g., first lithium metal foil) in a battery cell interior of a battery cell enclosure such that the first lithium metal foil contacts a first portion of an enclosure. In some embodiments, the first portion of the battery cell enclosure corresponds to a first battery cell terminal.

The method 300 also includes disposing (block 304) a second lithium metal source (e.g., second lithium metal foil) in the battery cell interior of the battery cell enclosure such that the second lithium metal foil contacts a second portion of the battery cell enclosure. In some embodiments, the second portion of the battery cell enclosure corresponds to a second battery cell terminal. An electrical insulator may be disposed between the first portion of the battery cell enclosure and the second portion of the battery cell enclosure to electrically isolate the first battery cell terminal from the second battery cell terminal.

The method 300 also includes administering (block 306) a pre-lithiation process such that active lithium corresponding to the first lithium metal foil and the second lithium metal foil is transferred to a battery cell anode of a battery cell electrode assembly. In some embodiments, a voltage applicator may be employed to apply a voltage to the first lithium metal foil (e.g., by way of the first portion of the battery cell enclosure) and/or to the second lithium metal foil (e.g., by way of the second portion of the battery cell enclosure) to initiate the pre-lithiation process. Upon completion of the pre-lithiation process, the first and second lithium metal foils may be depleted and/or formation of the battery cell may be completed.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A small format lithium-ion battery cell pre-lithiation assembly, comprising:
an enclosure comprising a first portion corresponding to a first battery cell terminal and a second portion corresponding to a second battery cell terminal;
an electrical insulator contacting the first portion and the second portion;
a first lithium metal foil disposed in the enclosure and abutting the first portion;
a second lithium metal foil disposed in the enclosure and abutting the second portion; and
an electrode assembly disposed in the enclosure between the first lithium metal foil and the second lithium metal foil.

2. The small format lithium-ion battery cell pre-lithiation assembly of claim 1, wherein the electrical insulator comprises an annulus having an opening, and a terminal contact of the first battery cell terminal extends through the opening.

3. The small format lithium-ion battery cell pre-lithiation assembly of claim 2, wherein the second portion comprises a first wall, a second wall opposing the first wall, and a body extending between the first wall and the second wall, the electrical insulator is disposed between the first portion and the first wall, the first wall comprises an additional annulus having an additional opening, and the terminal contact extends through the additional opening.

4. The small format lithium-ion battery cell pre-lithiation assembly of claim 1, wherein:
the first portion comprises a first disk and a first cylindrical body extending from the first disk;
the second portion comprises a second disk and a second cylindrical body extending from the second disk;
a first end of the first cylindrical body overlaps with a second end of the second cylindrical body; and
the electrical insulator is disposed between the first end and the second end.

5. The small format lithium-ion battery cell pre-lithiation assembly of claim 1, wherein the first lithium metal foil or the second lithium metal foil comprises a disk.

6. The small format lithium-ion battery cell pre-lithiation assembly of claim 1, wherein the first lithium metal foil or the second lithium metal foil comprises an annulus having an opening.

7. The small format lithium-ion battery cell pre-lithiation assembly of claim 1, wherein active lithium corresponding to the first lithium metal foil and the second lithium metal foil is configured to be transferred to an anode of the electrode assembly during a pre-lithiation process such that the first lithium metal foil and the second lithium metal foil are depleted.

8. The small format lithium-ion battery cell pre-lithiation assembly of claim 7, comprising a voltage applicator configured to apply a voltage to the small format lithium-ion battery cell pre-lithiation assembly during the pre-lithiation process.

9. The small format lithium-ion battery cell pre-lithiation assembly of claim 1, wherein the enclosure comprises a substantially cylindrical shape, and the substantially cylindrical shape comprises:
a height within a height range of 2 millimeters and 7 millimeters; and
a diameter within a diameter range of 5 millimeters and 15 millimeters.

10. A small format battery cell pre-lithiation assembly, comprising:
an enclosure;
a first lithium metal foil disposed in the enclosure and abutting a first portion of the enclosure, the first portion corresponding to a first battery cell terminal;
a second lithium metal foil disposed in the enclosure and abutting a second portion of the enclosure, the second portion facing the first portion and corresponding to a second battery cell terminal; and
an electrical insulator electrically isolating the first portion from the second portion.

11. The small format battery cell pre-lithiation assembly of claim 10, comprising an electrode assembly having an anode, a cathode, and a separator, wherein the electrode assembly is disposed between the first lithium metal foil and the second lithium metal foil.

12. The small format battery cell pre-lithiation assembly of claim 11, comprising a voltage applicator configured to apply a voltage to at least a portion of the small format battery cell pre- lithiation assembly during a pre-lithiation process in which active lithium corresponding to the first lithium metal foil and the second lithium metal foil is transferred to the anode.

13. The small format battery cell pre-lithiation assembly of claim 10, wherein:
the electrical insulator comprises an annulus having an opening, and a terminal contact of the first battery cell terminal extends through the opening; and
the second portion comprises a first wall, a second wall opposing the first wall, and a body extending between the first wall and the second wall, the electrical insulator is disposed between the first portion and the first wall, the first wall comprises an additional annulus having an additional opening, and the terminal contact extends through the additional opening.

14. The small format battery cell pre-lithiation assembly of claim 10, wherein:
the first portion comprises a first disk and a first cylindrical body extending from the first disk;
the second portion comprises a second disk and a second cylindrical body extending from the second disk;
a first end of the first cylindrical body overlaps with a second end of the second cylindrical body; and
the electrical insulator is disposed between the first end and the second end.

15. The small format battery cell pre-lithiation assembly of claim 10, wherein the enclosure comprises a substantially cylindrical shape, and the substantially cylindrical shape comprises:
a height within a height range of 2 millimeters and 7 millimeters; and
a diameter within a diameter range of 5 millimeters and 15 millimeters.

16. A method of forming a small format battery cell, comprising:
disposing a first lithium metal foil in a battery cell enclosure such that the first lithium metal foil contacts a first portion of the battery cell enclosure, the first portion corresponding to a first battery cell terminal;
disposing a second lithium metal foil in the battery cell enclosure such that the second lithium metal foil contacts a second portion of the battery cell enclosure, the second portion opposing the first portion and corresponding to a second battery cell terminal; and
administering a pre-lithiation process such that active lithium corresponding to the first lithium metal foil and the second lithium metal foil is transferred to a battery cell anode of a battery cell electrode assembly.

17. The method of claim 16, comprising disposing an electrical insulator between and in contact with the first portion and the second portion.

18. The method of claim 16, comprising administering the pre-lithiation process by applying a voltage to the first lithium metal foil or the second lithium metal foil.

19. The method of claim 16, comprising administering the pre-lithiation process until the first lithium metal foil and the second lithium metal foil are depleted.

20. The method of claim 16, comprising disposing electrolyte in the battery cell enclosure before administering the pre-lithiation process.
